(19) United States
(12) Patent Application Publication
(10) Pub. No.: US 2010/0119791 A1
(43) Pub. Date: May 13, 2010

(54) HEAT-PEELABLE PRESSURE-SENSITIVE ADHESIVE SHEET

(75) Inventors: Yukio Arimitsu, Osaka (JP); Daisuke Shimokawa, Osaka (JP)

Correspondence Address: EDWARDS ANGELL PALMER & DODGE LLP, P.O. BOX 55874, BOSTON, MA, 02205, US

(73) Assignee: Nitto Denko Corporation, Osaka (JP)

(21) Appl. No.: 12/451,742

(22) PCT Filed: May 28, 2008
(86) PCT No.: PCT/JP2008/059822

§ 371 Date: Nov. 30, 2009

(30) Foreign Application Priority Data
May 30, 2007 (JP) 2007 144177

(51) Int. Cl. B32B 7/10; B32B 5/16

(52) U.S. Cl. 428/214; 156/62.2

(57) ABSTRACT

Disclosed is a heat-peelable pressure-sensitive adhesive sheet which satisfactorily fits a rough surface, develops a sufficient adhesive strength even when a bonding face of adherend is rough, less causes chip scattering when used for holding, during dicing, a semiconductor substrate having a rough surface typically of an encapsulation resin, and, after the completion of working, can be smoothly peeled off from the adherend by heating, without applying stress on the adherend. Also disclosed are a method for working an adherend and a method for producing an electronic component using the heat-peelable pressure-sensitive adhesive sheet. The heat-peelable pressure-sensitive adhesive sheet includes a base material, an organic rubber-like elastic layer and a heat-expandable pressure-sensitive adhesive layer containing heat-expandable microspheres. The base material, the organic rubber-like elastic layer and the heat-expandable pressure-sensitive adhesive layer are arranged in the above-described order on or above at least one side of the base material. A thickness of the organic rubber-like elastic layer is 1.5 to 42 times a thickness of the heat-expandable pressure-sensitive adhesive layer.

### TECHNICAL FIELD

The present invention relates typically to a heat-peelable pressure-sensitive adhesive sheet that has superior tackiness to an adherend and can be peeled off at any time from the adherend through a heating treatment; and to a method for producing an electronic component using the heat-peelable pressure-sensitive adhesive sheet.

### BACKGROUND ART

Pressure-sensitive adhesive sheets have been used for working, such as in dicing process, of semiconductor substrates. An example of those known pressure-sensitive adhesive sheets is a curing-type pressure-sensitive adhesive sheet. Specifically, after a semiconductor substrate is affixed to the curing-type pressure-sensitive adhesive sheet and the working is performed thereon, the pressure-sensitive adhesive of the pressure-sensitive, adhesive sheet is polymerized and cured by the application of ultraviolet rays and/or radiations to thereby reduce its adhesive strength, and this eases the picking-up of the worked semiconductor substrate from the pressure-sensitive adhesive sheet (see Patent Document 1). Independently, another type of pressure-sensitive adhesive sheet, i.e., heat-peelable pressure-sensitive adhesive sheet, has been discussed for use in the working of a semiconductor substrate. The heat-peelable pressure-sensitive adhesive sheet includes a heat-expandable pressure-sensitive adhesive layer containing heat-expandable microspheres as a pressure-sensitive adhesive layer. Upon peeling-off from the worked semiconductor substrate, the heat-expandable pressure-sensitive adhesive layer of the pressure-sensitive adhesive sheet is heated and thereby loses its adhesive strength. The heat-peelable pressure-sensitive adhesive sheet does not need appliances for the application typically of ultraviolet rays in use, causes less electric charging upon peeling (detachment electric charging), and is superior in these points to the curing-type pressure-sensitive adhesive sheet. The heat-peelable pressure-sensitive adhesive sheet is, however, inferior in the following point to the curing-type pressure-sensitive adhesive. Specifically, the heat-peelable pressure-sensitive adhesive sheet does not fit the adherend so satisfactorily, because its pressure-sensitive adhesive layer is relatively hard due typically to the presence of the heat-expandable microspheres.

Some of semiconductor substrates to which a pressure-sensitive adhesive sheet is applied have a surface with a rough or uneven portion (protrusions and depressions) as an adherend surface, and these have been employed more and more recently. Specifically, some of them have a rough surface made of an encapsulation resin with a surface roughness of about 0.4 to 15 μm as the adherend surface, and others have, as the adherend surface, a surface with a mark 25 to 40 μm deep printed by the application of laser. However, when applied to such a semiconductor substrate having a rough or uneven surface for carrying out dicing thereon, the known heat-peelable pressure-sensitive adhesive sheet does not develop a sufficient adhesive strength to the adherend semiconductor substrate during dicing, because the heat-peelable pressure-sensitive adhesive sheet does not satisfactorily fit the rough or uneven surface. The insufficient adhesive strength causes several problems. For example, diced chips of the adherend semiconductor substrate are detached from the pressure-sensitive adhesive sheet and scatter (chip scattering) during dicing to lower the yield of product chips, and the scattered chips hit and damage a dicing blade.

Patent Document 1: Japanese Unexamined Patent Application Publication (JP-A) No. H06-49420

### DISCLOSURE OF INVENTION

### Problems to be Solved by the Invention

Accordingly, an object of the present invention is to provide a heat-peelable pressure-sensitive adhesive sheet as follows. The heat-peelable pressure-sensitive adhesive sheet can satisfactorily fit an uneven or rough surface, can thereby develop a sufficient adhesive strength even to a rough surface of an adherend, and less causes chip scattering even when used as a pressure-sensitive adhesive sheet for holding or fixing, during dicing, a semiconductor substrate having a rough surface such as a surface made of an encapsulation resin. In addition, after the completion of the working such as dicing, the heat-peelable pressure-sensitive adhesive sheet can be easily or smoothly peeled off from the adherend through heating, without applying stress on the adherend.

Another object of the present invention is to provide a method for working an adherend using the heat-peelable pressure-sensitive adhesive sheet that can satisfactorily follow an uneven surface and can be easily or smoothly peelable by heating.

### Means for Solving the Problems

After intensive investigations to achieve the objects, the present inventors have found that the objects can be achieved by arranging an organic rubber-like elastic layer between a base material (backing or carrier) and a heat-expandable pressure-sensitive adhesive layer, and setting the ratio of a thickness of the organic rubber-like elastic layer to a thickness of the heat-expandable pressure-sensitive adhesive layer within a specific range. The present invention has been made based on these findings.

Specifically, in an embodiment, the present invention provides a heat-peelable pressure-sensitive adhesive sheet comprising a base material, an organic rubber-like elastic layer and a heat-expandable pressure-sensitive adhesive layer containing heat-expandable microspheres. The base material, the organic rubber-like elastic layer and the heat-expandable pressure-sensitive adhesive layer are arranged in the above-described order on or above at least one side of the base material. A thickness of the organic rubber-like elastic layer is 1.5 to 42 times a thickness of the heat-expandable pressure-sensitive adhesive layer.

The present invention provides, in another embodiment, a method for working an adherend with a heat-peelable pressure-sensitive adhesive sheet. The heat-peelable pressure-sensitive adhesive sheet comprises a base material, an organic rubber-like elastic layer and a heat-expandable pressure-sensitive adhesive layer containing heat-expandable microspheres. The base material, the organic rubber-like elastic layer and the heat-expandable pressure-sensitive adhesive layer are arranged in the above-described order on or above at least one side of the base material. A thickness of the organic rubber-like elastic layer is 1.5 to 42 times a thickness of the heat-expandable pressure-sensitive adhesive layer. A surface roughness of the adherend is larger than a surface roughness of the heat-expandable pressure-sensitive adhesive layer.

The present invention provides, in yet another embodiment, a method for producing an electronic component comprising the step of working a semiconductor substrate with a heat-peelable pressure-sensitive adhesive sheet to produce the electronic component. The heat-peelable pressure-sensitive adhesive sheet comprises a base material, an organic rubber-like elastic layer and a heat-expandable pressure-sensitive adhesive layer containing heat-expandable microspheres. A thickness of the organic rubber-like elastic layer is 1.5 to 42 times a thickness of the heat-expandable pressure-sensitive adhesive layer. A surface roughness of the semiconductor substrate is larger than a surface roughness of the heat-expandable pressure-sensitive adhesive layer.

### Advantages

The heat-peelable pressure-sensitive adhesive sheet according to an embodiment of the present invention can securely hold even an adherend having a surface with a rough or uneven portion (hereinafter such surface is also briefly referred to as “rough surface”), because it satisfactorily fits the adherend having a rough surface and develops a sufficient adhesive strength (bond strength) thereto. Additionally, once the intended adhesion is completed, the heat-peelable pressure-sensitive adhesive sheet can be easily and smoothly peeled off from the adhered by heating without applying stress on the adherend, because it smoothly reduces or loses its adhesive strength as a result of heating.

The method for working an adherend according to an embodiment of the present invention enables secure holding even of a fine adherend having a rough surface and thereby enables accurate and smooth working of the adherend. In addition, the adherend can be easily removed and recovered from the heat-peelable pressure-sensitive adhesive sheet by heating after the completion of the working, because the heat-peelable pressure-sensitive adhesive sheet smoothly reduces or loses its adhesive strength as a result of heating.

In addition, a method for producing an electronic component enables secure holding of even a semiconductor substrate having a rough surface formed from an encapsulation resin or having an uneven surface formed as a result of marking through laser printing. This alleviates troubles such as chip scattering and chip defect (chipping) during dicing and performs working such as dicing in a trouble-free manner. After the completion of the working process, the electronic component can be removed from the heat-peelable pressure-sensitive adhesive sheet through heating without difficulties.

### BRIEF DESCRIPTION OF DRAWINGS

FIG. 1 is a schematic cross-sectional view illustrating a heat-peelable pressure-sensitive adhesive sheet according to an embodiment of the present invention.

FIG. 2 is a view illustrating how the adhesion to a rough surface is determined in tests performed in the examples.

### REFERENCE NUMERALS

11 base material

12 organic rubber-like elastic layer

13 heat-expandable pressure-sensitive adhesive layer

14 separator

21 stainless steel plate

22 heat-peelable pressure-sensitive adhesive sheet

23 poly(ethylene terephthalate) film 23 μm thick

### BEST MODES FOR CARRYING OUT THE INVENTION

### [Heat-Peelable Pressure-Sensitive Adhesive Sheet]

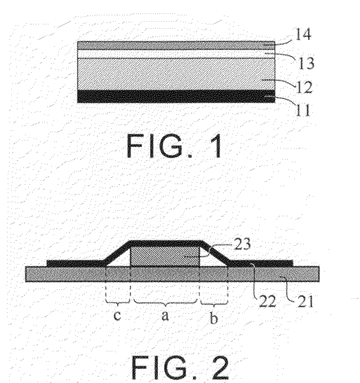

Heat-peelable pressure-sensitive adhesive sheets according to embodiments of the present invention will be illustrated with reference to the attached drawings. FIG. 1 is a schematic cross-sectional view illustrating a heat-peelable pressure-sensitive adhesive sheet according to an embodiment of the present invention. In FIG. 1, the reference numerals “11” stands for a base material (backing), “12” stands for an organic rubber-like elastic layer, “13” stands for a heat-expandable pressure-sensitive adhesive layer, and “14” stands for a separator, respectively. The organic rubber-like elastic layer 12 is a layer arranged between the base material 11 and the heat-expandable pressure-sensitive adhesive layer 13. Upon adhering to an adherend, the organic rubber-like elastic layer 12 helps the surface of the heat-peelable pressure-sensitive adhesive sheet to satisfactorily fit the surface dimensions of the adherend, and the heat-peelable pressure-sensitive adhesive sheet can thereby adhere to the adherend in a large adhesion area. Upon peeling-off of the heat-peelable pressure-sensitive adhesive sheet from the adherend through heating, this layer helps to reduce constraint on blistering (foaming) and/or expansion of the heated heat-expandable pressure-sensitive adhesive layer 13 in a plane direction of the heat-peelable pressure-sensitive adhesive sheet and helps the heat-expandable pressure-sensitive adhesive layer 13 to structurally three-dimensionally change to form a wavy structure. The separator 14 is a layer provided according to necessity for the protection of the surface of the heat-expandable pressure-sensitive adhesive layer, and is composed of a smooth and peelable film. The separator 14 may be provided according to necessity but unessential.

In the heat-peelable pressure-sensitive adhesive sheets according to the present invention, a thickness of the organic rubber-like elastic layer 12 falls within a range of from 1.5 to 42 times, preferably from 2 to 18 times, more preferably from 3 to 12 times, and especially preferably from 4 to 8 times a thickness of the heat-expandable pressure-sensitive adhesive layer 13. The organic rubber-like elastic layer 12 is configured to be relatively flexible and deformable. In contrast, the heat-expandable pressure-sensitive adhesive layer 13 is relatively hard and less deformable. A thickness of the organic rubber-like elastic layer 12 herein is to be larger than and to be within the above-specified ratio to a thickness of the heat-expandable pressure-sensitive adhesive layer 13. This helps the heat-expandable pressure-sensitive adhesive layer 13 to satisfactorily fit the unevenness of the surface of an adherend upon affixation, because the organic rubber-like elastic layer 12 softens the unevenness of the surface of the adherend. This prevents the occurrence of pop-off (delamination) and bubbles inserted between the adherend and the heat-peelable pressure-sensitive adhesive sheet. Accordingly, the pressure-sensitive adhesive layer can adhere to the adherend in a larger adhesion area on the surface and can develop a sufficient adhesive strength to the adherend. If a thickness of the organic rubber-like elastic layer 12 is less than 1.5 times a thickness of the heat-expandable pressure-sensitive adhesive layer 13, the organic rubber-like elastic layer 12 may not satisfactorily fit the rough surface of the adherend to cause pop-off and/or bubbles and thereby may show an inferior adhesive strength. If a thickness of the organic rubber-like elastic layer 12 is considerably larger than and is more than 42 times a thickness of the heat-expandable pressure-sensitive adhesive layer 13, the pressure-sensitive adhesive sheet may not be smoothly peeled off from the adherend by heating.

### (Base Material)

The base material 11 serves as a support or carrier in the heat-peelable pressure-sensitive adhesive sheet. Of materials for the base material 11, a plastic film or sheet is generally employed. The materials are, however, not limited thereto and include suitable thin articles such as paper, fabrics, nonwoven fabrics, and metallic foils; laminates of any of these materials with a plastic; and laminates of plastics with each other. Though not critical, a thickness of the base material can be chosen within a range of, for example, from 5 to 250 μm.

### (Heat-Expandable Pressure-Sensitive Adhesive Layer)

The heat-expandable pressure-sensitive adhesive layer 13 may be formed from a pressure-sensitive adhesive in combination with heat-expandable microspheres. The pressure-sensitive adhesive can be chosen from known, suitable pressure-sensitive adhesives without limitation. Of such pressure-sensitive adhesives, preferred are pressure-sensitive adhesives mainly containing such a rubber material or resin as to allow and not to constrain the blistering and/or expansion of the heat-expandable microspheres upon heating.

Exemplary base polymers for constituting such pressure-sensitive adhesives include polymers such as natural rubbers, synthetic rubbers, acrylic polymers, vinyl alkyl ether polymers, silicone polymers, polyesters, polyamides, urethane polymers, and styrene-diene block copolymers. These polymers, if used as base polymers, may be combined with one or more hot-melt (thermofusible) resins having a melting point of about 200° C. or lower so as to improve their creep properties.

Among these base polymers, acrylic copolymers are preferably used. Such acrylic copolymers preferably contain, as a main monomer component, an alkyl (meth)acrylate whose alkyl group having 20 or less carbon atoms. Exemplary alkyl groups having 20 or less carbon atoms include methyl group, ethyl group, propyl group, butyl group, amyl group, hexyl group, heptyl group, 2-ethylhexyl group, isooctyl group, isodecyl group, dodecyl group, lauryl group, tridecyl group, pentadecyl group, hexadecyl group, heptadecyl group, octadecyl group, nonadecyl group, and eicosyl group. Each of different alkyl (meth)acrylates can be used alone or in combination as main monomer components. Such alkyl (meth)acrylates generally occupy 50 percent by weight or more of the base polymer constituting the pressure-sensitive adhesive.

Where necessary, the acrylic copolymer may further contain one or more suitable copolymerizable monomers, in addition to the alkyl (meth)acrylates, in order typically to improve or modify properties such as cohesive strength and thermal stability. Exemplary copolymerizable monomers include carboxyl-containing monomers such as acrylic acid, methacrylic acid, carboxyethyl acrylate, carboxypentyl acrylate, itaconic acid, maleic acid, fumaric acid, and crotonic acid; acid anhydrides such as maleic anhydride and itaconic anhydride; hydroxyl-containing monomers such as hydroxyethyl (meth)acrylates, hydroxypropyl (meth)acrylates, hydroxybutyl (meth)acrylates, hydroxyhexyl (meth)acrylates, hydroxyoctyl (meth)acrylates, hydroxydecyl (meth)acrylates, hydroxylauryl (meth)acrylates, and (4-hydroxymethylcyclohexyl)methyl (meth)acrylates; sulfo-containing monomers such as styrenesulfonic acid, allylsulfonic acid, 2-(meth)acrylamido-2-methylpropanesulfonic acid, (meth)acrylamidopropanesulfonic acids, sulfopropyl (meth)acrylates, and (meth)acryloyloxynaphthalenesulfonic acid; amide monomers and N-substituted amide monomers, such as (meth)acrylamide, as well as N,N-dimethyl(meth)acrylamide, N-butyl(meth)acrylamide, N-methylol(meth)acrylamide, and N-methylolpropane(meth)acrylamide; alkylamino (meth)acrylate monomers such as aminoethyl (meth)acrylates, aminoethyl (meth)acrylates, N,N-dimethylaminoethyl (meth)acrylates, and t-butylaminoethyl (meth)acrylates; alkoxyalkyl (meth)acrylates monomers such as methoxyethyl (meth)acrylates and ethoxyethyl (meth)acrylates; maleimide monomers such as N-cyclohexylmaleimide, N-isopropylmaleimide, N-laurylmaleimide, and N-phenylmaleimide; itaconimide monomers such as N-methylitaconimide, N-ethylitaconimide, N-butylitaconimide, N-octylitaconimide, N-2-ethylhexylitaconimide, N-cyclohexylitaconimide, and N-laurylitaconimide; succinimide monomers such as N-(meth)acryloyloxymethylenesuccinimides, N-(meth)acryloyl-6-oxyhexamethylenesuccinimides, and N-(meth)acryloyl-8-oxyoctamethylenesuccinimides; vinyl monomers such as vinyl acetate, vinyl propionate, N-vinylpyrrolidone, methylvinylpyrrolidone, vinylpyridine, vinylpiperidone, vinylpyrimidine, vinylpiperazine, vinylpyrazine, vinylpyrrole, vinylimidazole, vinyloxazole, vinylmorpholine, N-vinylcarboxamides, styrene, α-methylstyrene, and N-vinylcaprolactam; cyano-acrylate monomers such as acrylonitrile and methacrylonitrile; epoxy-containing acrylic monomers such as glycidyl (meth)acrylates; glycolic acrylic ester monomers such as polyethylene glycol (meth)acrylates, polypropylene glycol (meth)acrylates, methoxyethylene glycol (meth)acrylates, and methoxypolypropylene glycol (meth)acrylates; other acrylic ester monomers such as tetrahydrofurfuryl (meth)acrylates, fluorinated (meth)acrylates, silicone (meth)acrylates, and 2-methoxyethyl acrylate; multifunctional monomers such as hexanediol di(meth)acrylates, (poly)ethylene glycol di(meth)acrylates, (poly)propylene glycol di(meth)acrylates, neopentyl glycol di(meth)acrylates, pentaerythritol di(meth)acrylates, trimethylolpropane tri(meth)acrylates, pentaerythritol tri(meth)acrylates, dipentaerythritol hexa(meth)acrylates, epoxy acrylates, polyester acrylates, and urethane acrylates; and other monomers such as isoprene, butadiene, isobutylene, and vinyl ethers. Each of different copolymerizable monomers can be used alone or in combination.

The base polymer constituting the heat-expandable pressure-sensitive adhesive layer 13 can be prepared by subjecting the above monomer component(s) to polymerization. Though not especially limited, the polymerization can be performed by adding a polymerization initiator and carrying out a suitable known polymerization process such as solution polymerization, bulk polymerization, or emulsion polymerization.

Where necessary, a variety of additives may be incorporated into the pressure-sensitive adhesive constituting the heat-expandable pressure-sensitive adhesive layer 13. Exemplary additives include known or common additives including tackifier resins such as rosin resins, terpene resins, petroleum resins, coumarone-indene resins, and styrenic resins; crosslinking agents such as epoxy crosslinking agents, isocyanate crosslinking agents, and multifunctional acrylate crosslinking agents; fillers; colorants such as pigments and dyestuffs; antioxidants; ultraviolet-absorbers; and surfactants. These additives may be used each in an amount generally employed in pressure-sensitive adhesives.

Exemplary heat-expandable microspheres for use herein include heat-expandable microspheres that contain a shell-forming material and, present inside thereof, a suitable material capable of readily gasifying and expanding, such as isobutane, propane, or pentane. These heat-expandable microspheres may be prepared typically by a coacervation technique or interfacial polymerization technique. Exemplary shell-forming materials usable herein include materials that melt upon heating or that break as a result of thermal expansion, such as vinylidene chloride/acrylonitrile copolymers, poly(vinyl alcohol)s, poly(vinyl butyral)s, poly(methyl methacrylate)s, polyacrylonitriles, poly(vinylidene chloride)s, and polysulfones. Desirable heat-expandable microspheres for use herein are those having a ratio of cubic expansion of, for example, 5 times or more, preferably 7 times or more, and especially preferably 10 times or more, for satisfactory heat peelability.

The amount of the heat-expandable microspheres is not especially limited and can be suitably chosen depending on how much degree the heat-peelable pressure-sensitive adhesive layer 13 should expand (blister) and how much degree the adhesive strength should be decreased. The amount can be chosen within ranges of, for example, from 1 to 150 parts by weight, and preferably from 25 to 100 parts by weight, per 100 parts by weight of a base polymer constituting the heat-peelable pressure-sensitive adhesive layer mentioned below.

A thickness of the heat-expandable pressure-sensitive adhesive layer 13 can be chosen within ranges of, for example, from 5 to 30 μm, preferably from 5 to 20 μm, and more preferably from 5 to 15 μm. The heat-expandable pressure-sensitive adhesive layer 13, if being excessively thick, may not satisfactorily fit a rough surface, and this may often cause chip scattering and chip defect (chipping) when the heat-peelable pressure-sensitive adhesive sheet is used as a pressure-sensitive adhesive sheet for the holding of a semiconductor substrate during dicing. In contrast, if the heat-expandable pressure-sensitive adhesive layer 13 is excessively thin, the amount of the heat-expandable microspheres per unit area may be excessively small, and this may impede smooth or satisfactory peeling-off of the heat-peelable pressure-sensitive adhesive sheet from the adherend through heating.

### (Organic Rubber-Like Elastic Layer)

The organic rubber-like elastic layer 12 can made from, for example, any of materials having a Type D Shore D hardness of preferably 50 or less, and especially preferably 40 or less, as determined according to the American Society for Testing and Materials (ASTM) D-2240 standard, and examples of materials include natural rubbers, synthetic rubbers, and synthetic resins having rubber elasticity.

Examples of the synthetic rubbers and synthetic resins having rubber elasticity include synthetic rubbers such as nitrile rubbers, diene rubbers, and acrylic rubbers; and synthetic resins having rubber elasticity, such as polyolefins, polyesters, thermoplastic elastomers, ethylene-vinyl acetate copolymers, polyurethanes, polybutadienes, and flexible poly(vinyl chloride)s. Even inherently hard or rigid polymers, such as poly(vinyl chloride)s, can be used herein by suitably combining with compounding agents such as plasticizers and flexibilizers so as to develop rubber elasticity.

Alternatively, the above-mentioned pressure-sensitive adhesives can be used as a material constituting the organic rubber-like elastic layer 12. Typically, an acrylic pressure-sensitive adhesive containing an acrylic copolymer as a base polymer is preferred as the material constituting the organic rubber-like elastic layer 13.

A thickness of the organic rubber-like elastic layer 12 may be chosen within ranges of, for example, from 20 to 200 μm, preferably from 30 to 180 μm, and more preferably from 40 to 150 μm so that the ratio of a thickness of the organic rubber-like elastic layer 12 to a thickness of the heat-expandable pressure-sensitive adhesive layer 13 falls within the above-specified range. If the organic rubber-like elastic layer 12 is excessively thin, the heat-peelable pressure-sensitive adhesive sheet may not satisfactorily fit a rough surface and may fail to develop a sufficient adhesive strength. This may often cause chip scattering and chip defect (chipping) when the heat-peelable pressure-sensitive adhesive sheet is used as a pressure-sensitive adhesive sheet for the holding of a semiconductor substrate during dicing. In contrast, if the organic rubber-like elastic layer 12 is excessively thick, the heat-peelable pressure-sensitive adhesive sheet may be so flexible that is causes chip defect (chipping).

### [Method For Working Adherend]

As has been described, a heat-peelable pressure-sensitive adhesive sheet according to an embodiment of the present invention includes the base material 11, the organic rubber-like elastic layer 12 and the heat-expandable pressure-sensitive adhesive layer 13 containing heat-expandable microspheres. The base material, the organic rubber-like elastic layer and the heat-expandable pressure-sensitive adhesive layer are arranged in the above-described order on or above at least one side of the base material. A thickness of the organic rubber-like elastic layer 12 is 1.5 to 42 times a thickness of the heat-expandable pressure-sensitive adhesive layer 13. Upon application, the heat-peelable pressure-sensitive adhesive sheet can fit even a rough or uneven surface, affix thereto without suffering from pop-off and bubbles, and hold the adherend securely. In particular, the heat-peelable pressure-sensitive adhesive sheet can considerably satisfactorily fit an uneven or rough surface of such an adherend having a surface roughness larger than a roughness of the surface (adhesive face) of the heat-expandable pressure-sensitive adhesive layer 12. A surface roughness can be evaluated typically in terms of center line average height (arithmetical mean deviation of profile). The heat-peelable pressure-sensitive adhesive sheet can thereby be used for the holding (fixation) of an adherend during carrying out working on the adherend, by applying the sheet to a surface of such an adherend having a surface roughness larger than a roughness of the heat-expandable pressure-sensitive adhesive layer 13. The heat-peelable pressure-sensitive adhesive sheet can fix and hold the adherend securely and thereby enables fine, precise, and accurate working on the adherend. Even when the working causes a load on the adherend (work piece), the sheet can hold the adherend until the working is completed, without causing dislocation and delamination during the working. Examples of the working include, but are not limited to, printing, marking (stamping), laminating press, cutting, grinding, and washing.

After the completion of working, the heat-peelable pressure-sensitive adhesive sheet can be smoothly peeled off from the work piece (adherend) without difficulties through heating so as to allow the heat-expandable pressure-sensitive adhesive layer 13 to reduce or lose its adhesive strength. The heating treatment conditions are determined depending on, for example, how the surface of the adherend is, how much degree the adhesion area is decreased according typically to the type of the heat-expandable microspheres, how much degree the base material 11 and the adherend are thermally stable, and which the heating procedure is. The heating may be conduced, for example, at a temperature of 100° C. to 250° C. for 1 to 90 seconds typically with a hot plate, or for 5 to 15 minutes typically with an air-forced oven.

### [Method for Producing Electronic Component]

The heat-peelable pressure-sensitive adhesive sheet can be used for the working of a work piece (adherend) having a surface roughness larger than a roughness of the heat-expandable pressure-sensitive adhesive layer 13 of the heat-peelable pressure-sensitive adhesive sheet. Examples of the work piece (adherend) include semiconductor substrates such as silicon wafers; substrates made typically of ceramics, glass, or resins; electronic component assemblies including these substrates and interconnections patterned thereon; and encapsulation resin packages including these electronic component assemblies each sealed with an encapsulation resin such as epoxy resin. The work pieces are applied to and fixed to the heat-peelable pressure-sensitive adhesive sheet, diced into pieces of predetermined dimensions, and thereby yield electronic components.

The method for producing an electronic component according to an embodiment of the present invention enables accurate cutting of ultracompact and lightweight electronic component assemblies, such as chip-scale packages, without causing problems such as chip scattering and chip cracking, to thereby produce high-quality electronic components efficiently.

### EXAMPLES

The present invention will be illustrated in further detail with reference to an example below. It should be noted, however, the example is never construed to limit the scope of the present invention.

### Example 1

### Organic Rubber-Like Elastic Layer

A coating composition was prepared by mixing with and dissolving in toluene 100 parts by weight of an acrylic copolymer, 2 parts by weight of an isocyanate crosslinking agent (supplied by Nippon Polyurethane Industry Co., Ltd. under the trade name “CORONATE L”) and 30 parts by weight of a rosin-phenolic resin (supplied by Sumitomo Bakelite Co., Ltd. under the trade name “SUMILITERESIN”). The acrylic copolymer was composed of, as monomer components, 100 parts by weight of butyl acrylate, 10 parts by weight of vinyl acrylate, and 5 parts by weight of acrylic acid. The coating composition was applied to a polyester film 50 μm thick, dried, and thereby yielded an organic rubber-like elastic layer 70 μm thick.

### Heat-Expandable Pressure-Sensitive Adhesive Layer

A coating composition was prepared by uniformly dissolving or dispersing in toluene 100 parts by weight of an acrylic copolymer, 5 parts by weight of an isocyanate crosslinking agent (supplied by Nippon Polyurethane Industry Co., Ltd. under the trade name “CORONATE L”), and 70 parts by weight of heat-expandable microspheres (supplied by Matsumoto Yushi-Seiyaku Col, Ltd. under the trade name “Microsphere F30D”). The acrylic copolymer was composed of, as monomer components, 100 parts by weight of butyl acrylate, 10 parts by weight of vinyl acrylate, and 5 parts by weight of acrylic acid. The coating composition was applied to a separator, dried, and thereby yielded a heat-expandable pressure-sensitive adhesive layer 10 μm thick.

### Heat-Peelable Pressure-Sensitive Adhesive Sheet

The organic rubber-like elastic layer was affixed with the heat-expandable pressure-sensitive adhesive layer to give a heat-peelable pressure-sensitive adhesive sheet.

### Comparative Example 1

A heat-peelable pressure-sensitive adhesive sheet was prepared by the procedure of Example 1, except for forming the heat-expandable pressure-sensitive adhesive layer to a thickness of 70 μm.

### Comparative Example 2

A heat-peelable pressure-sensitive adhesive sheet was prepared by the procedure of Example 1, except for forming the organic rubber-like elastic layer to a thickness of 13 μm and forming the heat-expandable pressure-sensitive adhesive layer to a thickness of 10 μm.

### (Testing)

The heat-peelable pressure-sensitive adhesive sheets obtained by the example and comparative examples were tested on the following properties. The results are shown in Table 1.

### [Adhesive Strength]

Each of the heat-peelable pressure-sensitive adhesive sheets was applied to the surface of a stainless steel plate (SUS 304BA) and was then peeled off therefrom at a tensile speed of 300 mm/min and a peel angle of 180 degrees, and the adhesive strength upon the peeling was measured.

### [Heat-Peelability]

Each of the heat-peelable pressure-sensitive adhesive sheets was applied to the surface of a stainless steel plate (SUS 304BA 304BA) and thereby yielded a sample, the sample was heated to 100° C. for one minute, and whether the heat-peelable pressure-sensitive adhesive sheet was peeled off from the stainless steel plate as a result of heating was visually observed. A sample whose pressure-sensitive adhesive sheet was peeled off was evaluated as having good heat-peelability, and a sample whose pressure-sensitive adhesive sheet was not peeled off was evaluated as having poor heat-peelability.

### [Adhesion to Rough Surface]

How the adhesion to a rough surface was tested will be explained with reference to FIG. 2. Specifically, FIG. 2 is a schematic cross-sectional view illustrating a sample in tests for determining the adhesion to a rough surface. In FIG. 2, the reference numerals “21” stands for a stainless steel plate (SUS 304BA), “22” stands for a 20-mm wide cut piece of each of the heat-peelable pressure-sensitive adhesive sheets prepared by the example and comparative examples, and “23” stands for a poly(ethylene terephthalate) (PET) film 23 μm thick. The PET film was placed on the stainless steel plate, and each of the heat-peelable pressure-sensitive adhesive sheets was affixed thereto with a laminator at a pressure of 0.3 MPa and an application speed of 1 meter per minute. FIG. 2 is a cross-sectional view in a width direction (crosswise direction) of the heat-peelable pressure-sensitive adhesive sheet, and the heat-peelable pressure-sensitive adhesive sheet was affixed onto the film through lamination along a longitudinal direction of the heat-peelable pressure-sensitive adhesive sheet. The width “a” of the PET film was 20 mm. Regarding pop-off portions (non-adhered portions) “b” and “c”, the largest lengths b and c were measured, and the average of the largest length b and the largest length c was calculated. A sample was evaluated as showing good adhesion to a rough surface when the average was less than 200 μm; whereas a sample was evaluated as showing poor adhesion to a rough surface when the average was 200 microns or more.

TABLE 1

| | Adhesive strength | Heat- | Adhesion to rough surface | |
|---|---|---|---|---|
| | (N/20 mm) | peelability | Average (μm) | Evaluation |
| Example 1 | 18.9 | Good | 130 | Good |
| Comparative | 15.8 | Good | 250 | Poor |
| Example 1 | | | | |
| Comparative | 13.0 | Good | 340 | Poor |
| Example 2 | | | | |

### INDUSTRIAL APPLICABILITY

Heat-peelable pressure-sensitive adhesive sheets according to the present invention can securely hold even an adherend having a rough or uneven surface, because they satisfactorily fit such adherend and can develop a satisfactory adhesive strength thereto. Additionally, once the intended adhesion is accomplished, the heat-peelable pressure-sensitive adhesive sheets can be easily and smoothly peeled off from the adhered by heating, without applying stress on the adherend, because the sheets smoothly decrease or lose their adhesive strength as a result of heating.

The heat-peelable pressure-sensitive adhesive sheets having such superior properties enable accurate working on an adherend without difficulties, when they are used as pressure-sensitive adhesive sheets for the holding of the adherend during working. Typically, even semiconductor substrates having a rough surface made of an encapsulation resin or having a surface with a rough or uneven portion formed typically by laser printing can be securely held by the heat-peelable pressure-sensitive adhesive sheets, and this reduces troubles such as chip scattering and chip defect (chipping) upon cutting to thereby perform working such as dicing in a trouble-free manner.

1. A heat-peelable pressure-sensitive adhesive sheet, comprising:
a base material;
an organic rubber-like elastic layer; and
a heat-expandable pressure-sensitive adhesive layer containing heat-expandable microspheres,
wherein said base material, said organic rubber-like elastic layer and said heat-expandable pressure-sensitive adhesive layer are arranged in the above-described order on or above at least one side of said base material, and
wherein a thickness of said organic rubber-like elastic layer is 1.5 to 42 times a thickness of said heat-expandable pressure-sensitive adhesive layer.

2. A method for working an adherend with a heat-peelable pressure-sensitive adhesive sheet,
wherein the heat-peelable pressure-sensitive adhesive sheet comprises a base material, an organic rubber-like elastic layer and a heat-expandable pressure-sensitive adhesive layer containing heat-expandable microspheres,
wherein said base material, said organic rubber-like elastic layer and said heat-expandable pressure-sensitive adhesive layer are arranged in the above-described order on or above at least one side of said base material,
wherein a thickness of said organic rubber-like elastic layer is 1.5 to 42 times a thickness of said heat-expandable pressure-sensitive adhesive layer, and
wherein a surface roughness of the adherend is larger than a surface roughness of said heat-expandable pressure-sensitive adhesive layer.

3. A method for producing an electronic component, comprising the step of working a semiconductor substrate with a heat-peelable pressure-sensitive adhesive sheet to produce the electronic component,
wherein the heat-peelable pressure-sensitive adhesive sheet comprises a base material, an organic rubber-like elastic layer and a heat-expandable pressure-sensitive adhesive layer containing heat-expandable microspheres,
wherein said base material, said organic rubber-like elastic layer and said heat-expandable pressure-sensitive adhesive layer are arranged in the above-described order on or above at least one side of said base material,
wherein a thickness of said organic rubber-like elastic layer is 1.5 to 42 times a thickness of said heat-expandable pressure-sensitive adhesive layer, and
wherein a surface roughness of the semiconductor substrate is larger than a surface roughness of said heat-expandable pressure-sensitive adhesive layer.
